(19) United States
(12) Patent Application Publication
(10) Pub. No.: US 2008/0246748 A1
(43) Pub. Date: Oct. 9, 2008

(54) Laminated and tilled displays and methods of manufacturing the same

(76) Inventors: Micheal Cassidy, Dublin (IE); Alain Briancon, Poolesville, MD (US); David Corr, Dublin (IE); Michael Ryan, Dublin (IE)

Correspondence Address: MORGAN, LEWIS & BOCKIUS LLP, 1701 MARKET STREET, PHILADELPHIA, PA, 19103-2921, US

(21) Appl. No.: 12/077,788

(22) Filed: Mar. 21, 2008

Related U.S. Application Data
(60) Provisional application No. 60/896,101, filed on Mar. 21, 2007.

(51) Int. Cl. G09G 3/00; G02F 1/133

(52) U.S. Cl. 345/205; 349/149

(57) ABSTRACT

A display having a front plane, a back plane and a border edge. The display includes a color changing cell located behind the front plane of the device and a first and second electrically conducting attachment layer. The color changing cell includes an active color layer having at least one active color area. The active color layer is associated with a first electrically conducting layer which overlaps at least one active color area. The color changing cell also includes a counter layer associated with a second electrically conducting layer. A first electrically conducting attachment layer extends from the active color area and overlaps the first electrically conducting layer. A second electrically conducting attachment layer extends from the counter layer and overlaps the second electrically conducting layer. The display may be coupled to an electronic circuit for use in a variety of applications. The display may also be used to form a device having a plurality of displays.

### RELATED APPLICATIONS

This application claims the benefit of U.S. Provisional Application No. 60/896,101, filed Mar. 21, 2007, entitled “Expanded and Accelerated Commercial Road Map Items” which is incorporated herein by reference in its entirety.

### FIELD OF INVENTION

The present invention generally relates to displays and more particularly relates to thin displays that are printed.

### BACKGROUND OF THE INVENTION

Thin displays are becoming popular for use in many applications due to their low weight, high contrast ratio, and their manufacturability through printing. These displays are typically fabricated with electrically conductive tabs to be supplied electric energy from sources such as non-rechargeable or rechargeable battery, rectified RF field generated electricity, solar panels or equivalent devices. Displays are evolving to represent images and text, but also present color changes.

These thin displays (thickness can be as thin at 50 micrometers) can be used in a multitude of new factors that require rethinking the interconnection structure of these displays for both assembly as well as repairs of devices once deployed in the field. These devices vary from game boards to laminated plastic cards to billboards.

Glass-based displays (typically thicker because of the inherent thickness of the glass substrate), the connection to the rest of the device is typically performed through elastomeric zebra strips, heat-seal interconnects, or pin type connector.

For thinner plastic displays, these techniques are neither feasible nor cost effective. Rather, electrically conductive tabs are generally attached to the display exposed electrodes. These tabs are typically flimsy tabs extending outwardly from the display or bent around the exterior of the display package. As a result, the electrically conductive tabs are susceptible to breaking off or tearing and are easily damaged during processing and installation. In addition, because the electrically conductive tabs protrude beyond outline of the display, they create an irregular perimeter around the display that limits the form factors of the products using those displays.

When laminating such a display in a thin device, such as a smart card or smart label, a sink or pocket may be created by the space between the protruding tabs, resulting in surface defects that negatively affect the performance of the device in terms of surface flatness as stated in ISO 7816 series. It might require the introduction of planarization layers, a costly step that can lead to lower manufacturing yield.

Another significant drawback of conventional thin packaged display designs is that the protruding electrically conductive tabs typically require a soldering or welding step in order to make an electrical connection between the tabs and the electrical circuitry of the device into which they are installed. Depending upon the geometry of the device in which the displays are installed, this soldering or welding step may be difficult or impractical. It also restricts the form factor of the final device the display is integrated in by introducing extra area outside the footprint of the display.

Traditional thin displays are also less conducive to replacement in the field. This is a drawback for devices such for a digital billboard or surface of a large system such as car. In such configurations, displays are truly tiles that show fit together to form a larger surface. Tiles should be replaceable readily in the field without requiring a soldering iron or like equipment.

The present invention provides solutions to these problems.

### SUMMARY OF THE INVENTION

The present invention provides for a display having a front plane, a back plane and a border edge. The display includes a color changing cell located behind the front plane of the device and a first and second electrically conducting attachment layer. The color changing cell includes an active color layer having at least one active color area. The active color layer is associated with a first electrically conducting layer which overlaps at least one active color area. The color changing cell also includes a counter layer associated with a second electrically conducting layer. A first electrically conducting attachment layer extends from the active color area and overlaps the first electrically conducting layer. A second electrically conducting attachment layer extends from the counter layer and overlaps the second electrically conducting layer.

In one embodiment, the display may further include electrically conductive tape as anisotropic electrically conductive tape or an isotropic electrically conductive tape. In another embodiment, the electrically conducting attachment layer is made from anisotropic electrically conductive tape or an isotropic electrically conductive tape.

The color changing cell may be based on a variety of display devices which undergo changes in color the application of a voltage source to at least a pair of electrodes of the display devices. In one embodiment, the color changing cell is an electrochromic cell.

In accordance with the present invention, the device may be operatively coupled with an electronic circuit, wherein the electronic circuit is embedded under the back plane of the display. In one such embodiment, the electronic circuit may include computing capabilities, memory capabilities, communication capabilities, a plurality of address and/or a printed antenna.

The device of the present invention may be used in a variety of devices such as a smart card, a smart label, an electronically readable card, an RFID tag, an electrically powered label, a smart package, a medical device, a sensor, a temperature measurement device, or a wearable medical device.

The present invention also provides for a device including a plurality of self-adhesive displays having color changing cell located behind the front plan of the device and a plurality of electrically conducting attachment layer where the display is coupled to an electronic circuit. The device is operative coupled to at least one controller. In one embodiment, the controller implements a zero configuration networking algorithm. In another embodiment, the controller assigns to each display a color, an icon, a color change, a pixel, and an image, to thereby generate a device image. The self-adhesive devices may be associated with objects such as a vehicle, a billboard, an internal wall, a container, or an external wall.

### BRIEF DESCRIPTIONS OF THE DRAWING

The accompanying drawings, which are included to provide further understanding of the disclosure and are incorporated in and constitute a part of this specification, illustrate embodiments of the disclosure and, together with the description, serve to explain the principles of the disclosure.

FIG. 1 illustrates a perspective view of an electrochromic display where the two electrically conductive areas are shown.

FIG. 2 illustrates a bottom view of printed electrochromic display with a single addressable active color area.

FIG. 3 illustrates a bottom view of printed electrochromic display with two addressable active color areas.

FIG. 4 illustrates a bottom view of printed display where the electrically conductive attachment layer is deposed on the conductive electrodes of the display.

FIG. 5 illustrates a bottom view of printed display where electrically conductive attachment layer are attached to the conductive electrodes of the display used as a puzzle piece

FIG. 6 illustrates a bottom view of a display where electrically conductive attachment layers are deposed on the back of the display for a dual icon display.

FIG. 7 illustrates a bottom view of the electrically conductive attachment layer for the COM layer composed of metal and adhesive films.

FIG. 8 illustrates a bottom view of the electrically conductive attachment layer for an active color area, where the electrically conductive attachment layer is composed of metal and adhesive film.

FIG. 9 illustrates a bottom of thin display where electrically conductive attachment layers are applied essentially as a frame at the periphery of the display.

FIG. 10 illustrates a bottom of thin display where a thin electronic circuit is integrated underneath the display where the attachment layer is a frame.

FIG. 11 illustrates a bottom thin display where a thin electronic circuit is integrated underneath the display on top a secondary substrate where the attachment layer is a frame.

FIG. 12 illustrates a bottom thin display where a thin electronic circuit is integrated underneath the display where the attachment layer is on a single side of the display.

FIG. 13 illustrates a perspective of view of a self adhesive display being created where the attach layers are aligned then pressed on conductive ink traces connected to other components of the laminated module (not shown).

FIG. 14 illustrates a perspective view of a self adhesive display being integrated to a control structure where the respective attach layers are aligned them pressed to one another.

FIG. 15 illustrates a perceptive view of a device composed of multiple sub-displays.

FIG. 16 illustrates a logical view of the control of such a device managed by the logical entities of sub-displays and display controllers.

FIG. 17 illustrates the record structure for a sub-display controller.

FIG. 18 illustrates the record structure for a display controller.

FIG. 19 illustrates the time sequence dealing with the replacement of a sub-display leveraging the self-discovery capabilities of the sub-display controller.

### DETAILED DESCRIPTION OF THE DISCLOSURE

Reference will now be made in detail to the preferred embodiments of the present disclosure, examples of which are illustrated in the accompanying drawings. Wherever possible, the same reference numbers will be used throughout the drawings to refer to the same or like parts.

The present invention provides for displays having improved constructions, packaging, and associated electronics are provided. The displays are designed to provide at least one of the following characteristics: 1) some of the displays provided herein do not require a soldering or welding step in order to be connected to an external electronic device; 2) some of the displays provided herein include reinforced electrically conductive tabs; 3) some of the displays provided herein have irregular perimeter shape which helps eliminate surface defects when the displays are incorporated into small and/or flat electric devices; 4) some of the displays provided therein have electronics integrated within their footprint; 5) certain displays can constitute the entire side of a device; 6) certain displays can readily assembled into a large displays. The display constructions provided herein are well suited for the design of thin, flat-profile displays, including laminated display structures and large display structures.

The connection of the display to the an additional electronic system is one of the areas of improvement uniquely enabled by the introduction of all print (and at times low temperature manufacturing process, one where the maximum manufacturing temperature is in the range of 80° C. to 120° C.) as described in U.S. patent application Ser. No. 12/______, filed on Mar. 21, 2008 and incorporated herein by reference in its entirety.

An important side benefit of the low manufacturing printable nature of those displays is that electronic components can now be printed on the same substrate as the display itself or under the display resulting in a more self sustaining display and electronic device. The electronic components can provide functionality associated with the display itself (such as regular of voltage or current being applied to it). The electronic components can also be used to provide functionality at the device level.

The present invention provides for an easily laminable display and tile-able displays. The display has a front plane, a back plane and a border edge. The display includes a color changing cell located behind the front plane of the device and a first and second electrically conducting attachment layer. In one embodiment, the front plane of the device includes the front side of a substrate used in the device. In one embodiment, the back plane of the device is behind the final layer used to construct the color changing cell. The color changing cell includes an active color layer having at least one active color area. The active color layer is associated with a first electrically conducting layer which overlaps at least one active color area. The color changing cell also includes a counter layer associated with a second electrically conducting layer. A first electrically conducting attachment layer extends from the active color area and overlaps the first electrically conducting layer. The second electrically conducting attachment layer extends from the counter layer and overlaps the second electrically conducting layer. Electric components may be placed on the back plane of the device.

In one embodiment, the device includes at least two first electrically conductive attachment layers extending from under at least two active color areas and overlapping the first electrically conducting layer. In one such embodiment, an electrically conductive adhesive tape is disposed onto each of the at least two first electrically conductive attachment layers.

The color changing cell may be based on a variety of display devices which undergo changes in color the application of a voltage source to at least a pair of electrodes of the display devices. Representative display devices include electrochromic displays, thermo-chromic displays, electroluminescent displays, electrowetting displays, electrophoretic displays and other reflective and emissive displays. For an electrochromic display, the display print stack includes layers having representative compositions of: a transparent nanostructured semiconducting metal oxide; an electrolyte; an electrochromophore, a reflective metal oxide, an isolator material. One of such layers is common to the component print stack. Representative materials used to make an electrochromic display are described in U.S. Pat. No. 6,301,038, U.S. Pat. No. 6,605,239, U.S. Pat. No. 6,755,993, U.S. Pat. No. 6,870,657, U.S. Pat. No. 6,879,424 and U.S. Pat. No. 7,054,050 each of which is incorporated herein by reference in its entirety. For a thermo-chromic display, one of the layers within the display print stack includes at least one thermochromic material which changes color as the temperature of the material increases beyond a thermal threshold. The display print stack may also include material to form a thermal insulation layer. Representative materials used to make a thermochromic display are described in U.S. Pat. No. 5,557,208 which is incorporated herein by reference in its entirety. For a printed electroluminescent display, one of the layers within the display print stack includes glass encapsulated phosphors or phosphor crystals embedded in a polymer binder. An electrophoretic display print stack includes at least one layer containing an electronic ink. Representative electronic inks are described in U.S. Pat. No. 5,930,026, U.S. Pat. No. 5,754,332, and U.S. Pat. No. 6,850,355 each of which is incorporated herein by reference in its entirety.

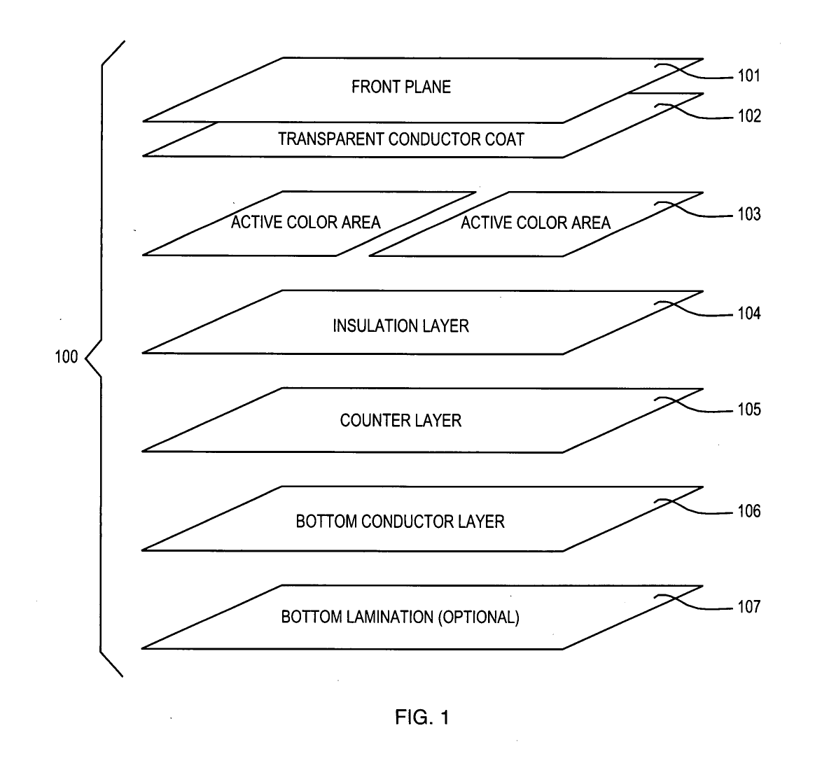

In one embodiment, the color changing cell is based on an electrochromic display structure 100 as illustrated in FIG. 1. This electrochromic display structure 100 is viewed from the top of the display through the top substrate 101. This substrate 101 includes flexible material such as PET, PETG, PEN, thin glass, bendable glass, or any other transparent material. On this substrate 101, a transparent conductor material (metal, organic, semiconductor) layer 102 is deposited on part of the inside of the display. The deposition may be performed using a multiple of means such as printing, sputtering, ion beam deposition. On the bottom interface of layer 102, at layer 103 of electrochromic material is deposited. The layer 103 can be patterned, creating a plurality of active color areas or un-patterned creating a single active color area. The areas(s) of electrochromic material function as one or more electrodes (“SEG”). In one embodiment, the areas of electrochromic material function as an anode. In one embodiment, the area of the transparent conductor 102 layer will be substantially covered by layer 103, having the one or more active color areas 103. In another embodiment, the transparent conductor 102 layer will be incompletely covered by the layer 103, having the one or more active color areas is constructed with material with good lateral conductivity. In yet another embodiment, as long as there is contact between the transparent conductor layer 102 and layer 103, having the one or more active color areas 103, the color changing cell will change color. An insulation layer 104 is placed next to layer 103 covering its entire area to insulate the one or more active color areas from the charge reservoir layer 105 (“COM”). In one embodiment, the layer 105 functions as a cathode. Layer 104 is a porous insulating layer that allows ionic motion but precludes electronic motion. The area of the charge reservoir layer 105 fits within the area of the insulation layer 104. A bottom counter layer 106, made of conductive material, is deposited below and covers the entire area of the charge reservoir layer 105. This layer 106 can be patterned or unpatterned. In one embodiment, layer 106 can be conductive over its entire area. In another embodiment, layer 106 can be partially conductive if a coating has been applied. An optional lamination layer 107 may be applied to the bottom conductor layer 106 for protection.

In one embodiment, the insulation layer 104 is typically a porous structure saturated in electrolyte is preferably electrically insulating, but nothing precludes the inclusion of redox elements in the electrolyte to create a self-erasing cell. The electrolyte, in charge reservoir layer 105, should be as pure as possible, but nothing precludes the inclusions of impurities and/or chemical elements/compound used to perform irreversible transformation of the one or more active color areas 103.

A color changing cell based on an electrochromic display will have a variety of properties depending on the electrochromic material used for the cell. The electro-optical effects can be bistable (where an image is retained on the display until forced to disappear), self-erasing (where an image disappears shortly after the application of charge), or permanent (where an image appears and last forever after the application of a charge). The electro-optic effects of these electrochromic displays may be based on reduction effect (where electrons are being provided to a chromophore structure), oxidation effect (where electrons are being removed from the chromophore structure) or change in pH level (where protons are being generated or removed as in U.S. Pat. Nos. 6,879,424, 7,054,050). The electrochromic material can be deposited on films or part of the electrolyte structure. The electrolyte structure can be a liquid, water based, a gel, a polymer, an olygo-polymer, or a molten salt (e.g. ionic liquid).

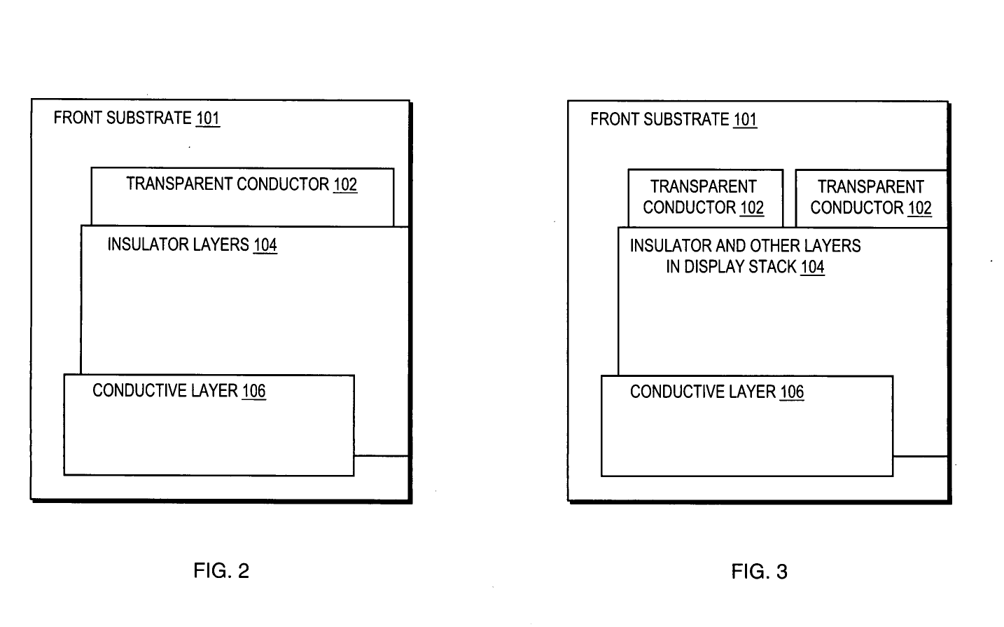

FIG. 2 shows an exemplary electrochromic display 100 with a single addressable active color area or SEG electrode (albeit without the protection provided by the optional laminate 107). The device is shown from the bottom view to show the relative overlaps of the different layers of the display that can be viewed from beneath the display. The front substrate 101 occupies the largest area. The transparent conductor layer 102 is deposed on a portion of the front substrate. The layer 103 containing the one or more active color areas is positioned between the transparent conductor layer 102 and the insulation layer 104. The insulator layer 104 covers a portion of the transparent conductor layer and the entire area of the one or more active color area 103. The conductive layer 106 is at the bottom of the display overlapping the insulator layer 104. As shown here conductive layer 106 can also overlap the front substrate 102. This structure allows a single active color area to be energized through charges between passed through the conductive layer 106 and transparent conductor layer 102.

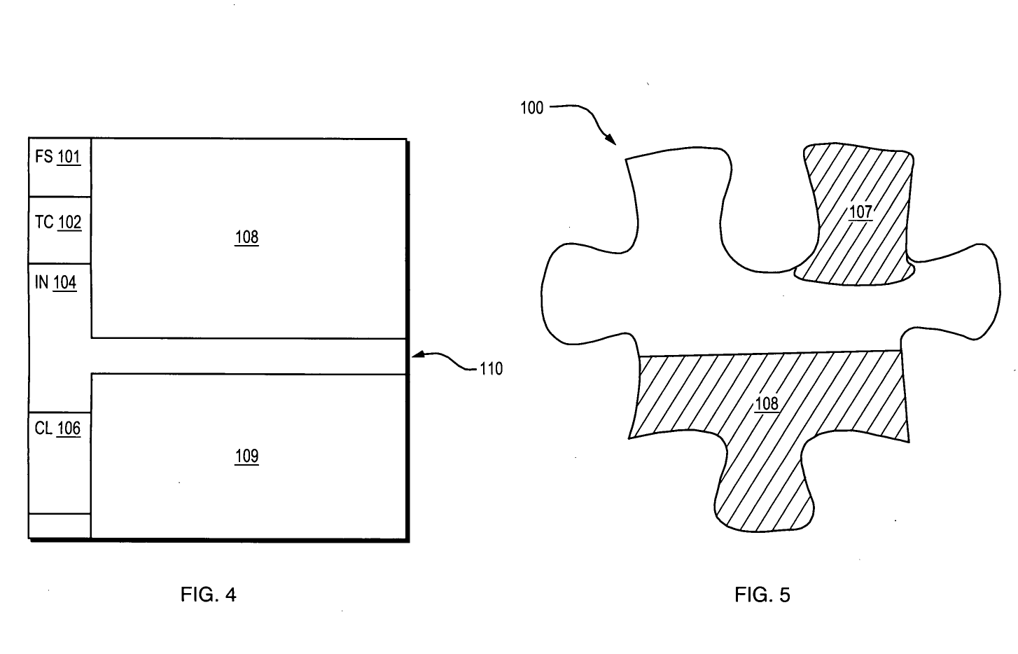

FIG. 3 illustrates the overlap of layers a second exemplary electrochromic display 101 with two separately addressable active color areas. Again the Figure illustrates the bottom of the display 100 to show the relative overlaps of the different layers of the display 100 that are exposed. The front substrate 101 occupies the largest area and transparent conductors 102 are deposed on a portion of the front substrate. The insulator layer 104 covers a portion of the transparent conductor 102 and the entire areas of two active color areas 103. The conductive layer 106 is at the bottom of the display. It overlaps the insulator layer 104 and as shown here it can overlap with the front substrate 102. It is important that the two transparent conductor areas 102 do to not touch so each active color area of the display can be addressed individually.

In some embodiments, the displays include an electrically conducting attachment layer attached to the bottom of the display 100. In one such embodiment, the attachment layers can be made to cover the entire backplane of the display except for a gap that that separate them. This gap can be created through the printing of the attachment systems or through laser or UV etching. In one embodiment, the gap can be as small as 25 micrometers. In another embodiment, the gap is at least 50 micrometers. The advantage of such a structure is that it provides an electrical ground plate that can be used to shape electrical and magnetic field when the device incorporating the display is a wireless device of. It can also be used as a shield system to reduced unwarranted electrical or thermal effects.

FIG. 4 illustrates such an embodiment showing the placement of two electrically conducting attachment layers to the bottom of the exemplary display device 100, previously illustrated in FIG. 2. With reference to FIG. 4, an electrically conducting attachment layer 108 extends outwardly from the active color area 102 and a second electrically conducting attachment layer 109 extends from the counter COM conductive layer 106. Attachment layer 107 for the display active area 103 overlaps with the transparent conductor layer 102 to create an electrical contact. The attachment layer 108 for the charge reservoir layer 105 overlaps with the conductive layer 106 to create an electrical contact. A gap 110 must exist between the two attachment layers.

This attachment system has the advantage to fit with the display parameter, thus reducing the overhead need to integrate the display in a device. It can also be shaped in case the display has an irregular shape such as puzzle piece. FIG. 5 shows an exemplary electrochromic display in the shape of a puzzle piece with a single addressable active color area where the attachment layers 108 and 109 have been added.

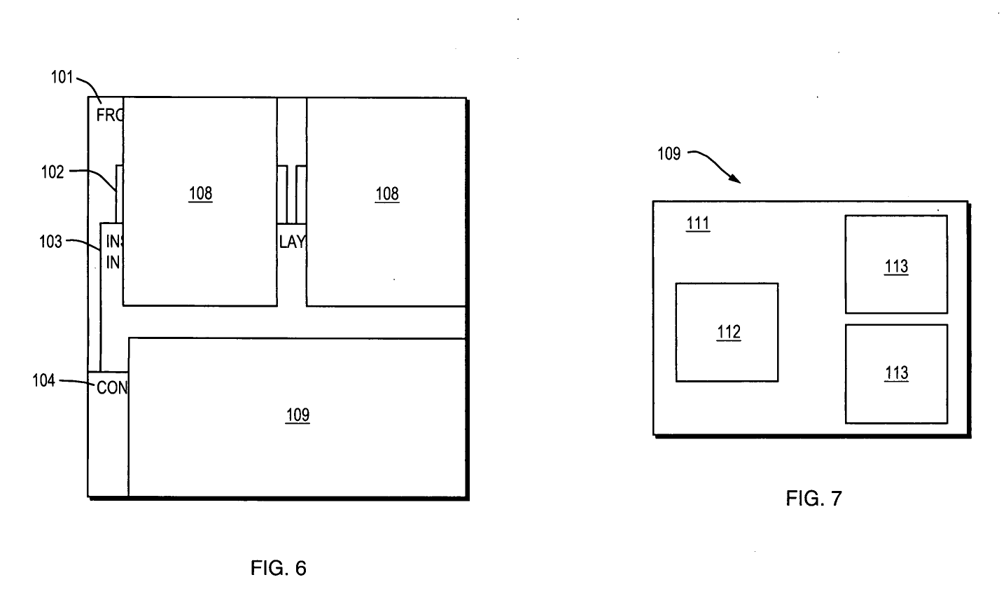

FIG. 6 shows another exemplary electrochromic display with two addressable active color areas where the attachment layers 108 and 109 have been added to the bottom of the exemplary display device 100 previously illustrated in FIG. 2. Each active color area is covered by an attachment layer 108 and overlaps with the transparent conductor layer 102 to create an electrical contact.

FIG. 7 illustrates another example of positioning the electrically conductive attachment layers to the bottom of an exemplary display device as illustrated in FIG. 3. In one such embodiment, the electrically conductive attachment layers 107, 108 create a frame disposed around the parameter of the display except for a gap 110 that that separates them. The parameter frame may be a two-piece frame with a first electrically conductive attachment connected to the active color area and a second electrically conductive attachment connected to the COM conductive layer 106. The gap 110 can be created through the printing of the attachment systems or through laser or UV etching. In one embodiment, the gap can be as small as 25 micrometers. In another embodiment, the gap is at least 50 micrometers.

An advantage of this framing is to provide enhancement structural integrity to the display. Another advantage is that is allows electrical contact between adjacent displays. This simplifies greatly the connectivity to power sources and remove the need for a complicated backplane to support these multiple displays.

In one embodiment, the electrically conductive attachment layers are made of electrically conductive adhesive tape. In one embodiment, the electrically conductive adhesive tape may be isotropically conductive tape. In another embodiment, the electrically conductive adhesive tape may be a strip of z-axis anisotropically electrically conductive adhesive tape.

In another embodiment, the electrically conductive attachment layer is coated with a conductive film. In one embodiment, the conductive film is made of carbon. In another embodiment, the conductive film is made of a conductive polymer.

In another embodiment, strips of electrically conductive adhesive tape are disposed onto the first electrically conductive attachment layer and the second electrically conductive attachment layer. This allows the electrically conductive attachment layers to be electrically connected to an external electronic device without soldering or welding the attachment layers in place. Placement of conductive adhesive tape over the relevant parts of exposed surface of an electrically conductive attachment layer will provide electrical connections between the attachment layers and electrical contacts in a device into which the display is to be installed.

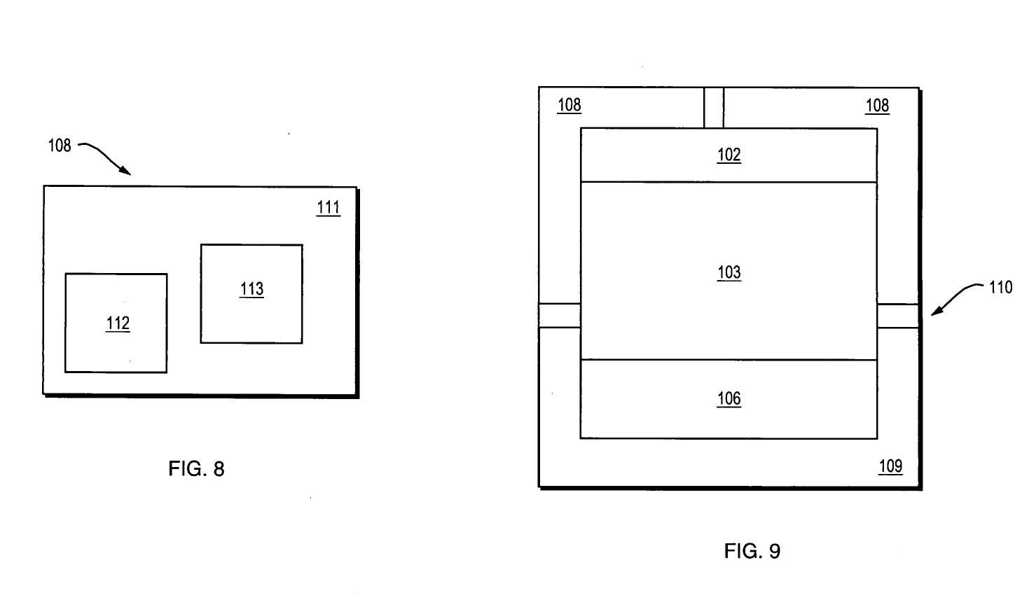

FIG. 8 illustrates the placement of electrically conductive adhesive tape onto an electrically conductive attachment layer 108 covering an active color area 103 (not shown). In some designs, a plurality of electrically conductive adhesive tapes 112, 113 may be placed on the electrically conductive attachment layer 108. This plurality of conductive adhesive tapes can then be attached directly on the conductive layer 102 of the display. Alternatively, the electrically conductive attachment layer 108 may be coated with a conductive film 111 then place on conductive layer 102. The conductive adhesive tape is then attached to the conductive film 111.

FIG. 9 illustrates the placement of electrically conductive adhesive tape onto an electrically conductive attachment layer 109 covering COM conductive layer 106 (not shown). In some designs, a plurality of electrically conductive adhesive tapes 112, 113 may be placed on the electrically conductive attachment layer 109. This plurality of conductive adhesive tapes can be attached directly on the COM conductive layer 106 of the display. Alternatively, the electrically conductive attachment layer may be coated with a conductive films 111 deposed on conductive layer 102 and the conductive adhesive tape then attached to the conductive film.

In one embodiment, the electrically conductive adhesive tape may be an isotropically conductive tape. In another embodiment, a strip of an anisotropically electrically conductive adhesive tape (i.e., tape that conducts only in the direction perpendicular to the plane of the tape) is placed over and bridging both electrically conductive attachment layers. In this embodiment, the strip of tape partially or entirely covers the space defined between the two tabs and creates a more regular perimeter for the display.

The electrically conductive adhesive tapes used to make the electrical contacts are typically made from adhesives having electrically conductive particles dispersed therein. These include, but are not limited to, pressure sensitive adhesives, heat sensitive adhesives, and heat curable adhesives. Specific types of adhesives that may be used to construct the electrically conductive adhesive tapes include, but are not limited to, acrylic adhesives, silicone adhesives, epoxy adhesives, and polyether amide adhesives. Electrically conductive fibers and particles may be dispersed in the adhesives include, but are not limited to, nickel particles, gold coated polymer particles, and silver coated glass particles. The binder adhesive is desirably a heat-activated adhesive that activates at temperatures of at least about 120 degree Celsius.

Suitable electrically conductive adhesive tapes are commercially available from 3M. Specific examples of isotropically electrically conductive tapes available from 3M include Electrically Conductive Tape 9713, Adhesive Film 9708. Specific examples of anisotropically electrically conductive tapes available from 3M include Electrically Conductive Tape 9703, Z-Axis Adhesive Film 7303.

Technical literature further describing tapes, anisotropic films, and anisotropic conductive tapes include, for example: U.S. Pat. No. 6,260,262; U.S. Pat. No. 5,422,200; U.S. Pat. No. 6,517,618; U.S. Pat. No. 6,293,470; U.S. Patent Appl. Publication No. 2003/0002132; U.S. Patent Appl. Publication No 2003/0209792; and U.S. Patent Appl. Publication No 2001/0015483.

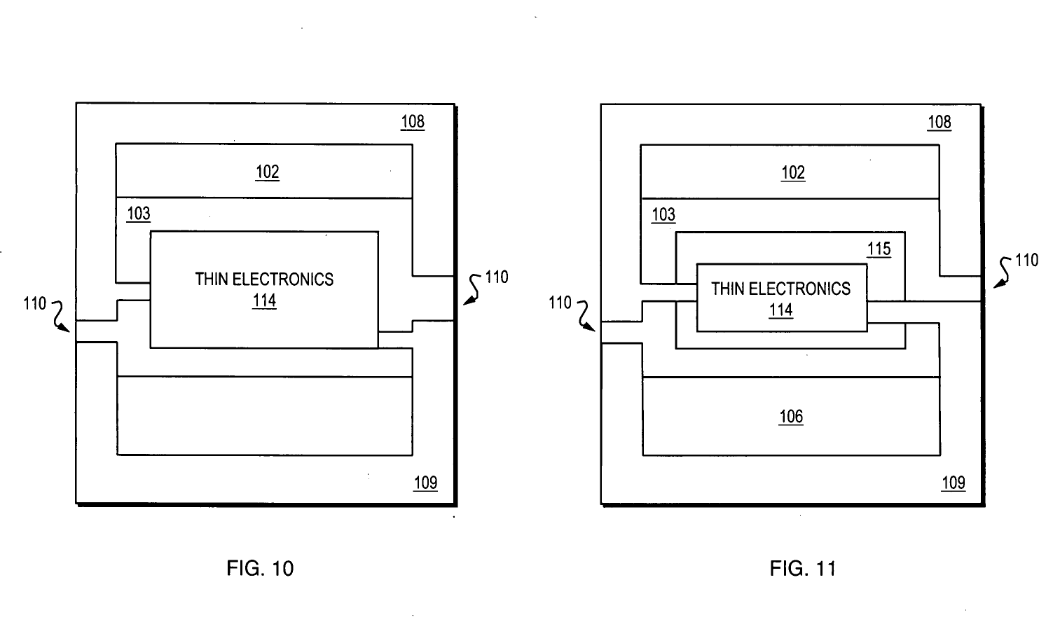

In another embodiment, the frame created by the electrically conductive attachment layers can be used to provide room for an electronic subsystem integrated on the outside of display but within its foot print. This approach has the advantage to support a tight integration with electronics that are thin. This circuitry can be deposed on the back of the display or added to substrate itself attached to the back of the display. One such embodiment is illustrated in FIG. 10 which shows electrochromic display, as previously illustrated in FIG. 2, with a single addressable active color area 103 where the electrically conductive attachment layers 108 and 109 have been added and form a frame along the periphery of the display. On the exposed side of insulating layer 104, electronic circuitry 114 is printed and powered through the electronically conductive attachment layer 108 for the active color area 103 and electronically conductive attachment layer 109 for the COM layer 106.

FIG. 11 shows another exemplary electrochromic display, as previously illustrated in FIG. 2, with a single addressable active color area with electrically conductive attachment layers 107 and 109 forming a frame along the periphery of the display. An insulating substrate 115 has been placed onto the exposed side of insulating layer 104. On top of insulating substrate 115, electronic circuitry 114 is printed and powered through the electrically conductive attachment layer 108 for the active color area and the electrically conductive attachment layer 109 for the COM conductive layer 106.

The display may operatively coupled with electronic circuitry. In one embodiment, the electronic circuitry is embedded under the back plane of the display. In another embodiment, the electronic circuitry is external to the display device. In another embodiment, the electronic circuitry is disposed on the back plane of the display.

The electronic circuitry may perform a variety of functions. In one embodiment, the electronic circuit includes computing capabilities. In another embodiment, the electronic circuit includes memory capabilities. In still another embodiment, the electronic circuit includes communication capabilities. In still yet another embodiment, the electronic circuit includes a plurality of addresses. In another embodiment, the electronic circuit includes a printed antenna.

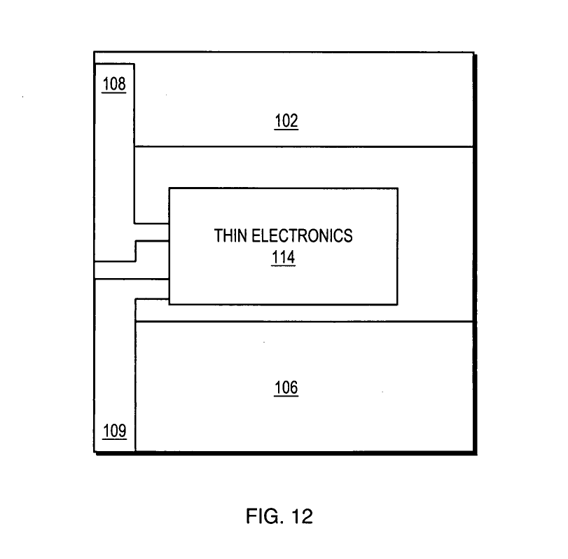

FIG. 12 shows yet another exemplary electrochromic display, as previously illustrated in FIG. 2, with a single addressable active color area 103 where the attachment layers 108 and 109 have been added on one side of display. Electronic circuitry 114 is printed on top of insulating layer 104 and powered through the electrically conductive attachment layer 108 for the active color area and the electrically conductive attachment layer 109 for the COM conductive layer 106.

The displays may be used in a broad range of devices. However they are particularly well suited for use inside smart cards, smart labels, RFID tags, medical devices, and other small devices that require high temperature/high pressure lamination processing.

A basic and novel feature of some of the embodiments is that displays can be made without the need to solder or weld electrically conductive tabs by using the electrically conductive adhesive tape. Another basic and novel feature is the use of conductive adhesives, including curable conductive adhesives, to provide electrical connections between electrically conductive tabs and external devices. These features represent important manufacturing improvements.

As discussed above, the display includes electrically conductive attachment layers 108, 109 which may be made of electrically conductive adhesive tape or have electrically conductive adhesive tape placed on a separate electrically conductive attachment layer. The inclusion of the electrically conductive adhesive tape, by either embodiment, creates a self-adhesive display which can be attached to a variety of structures.

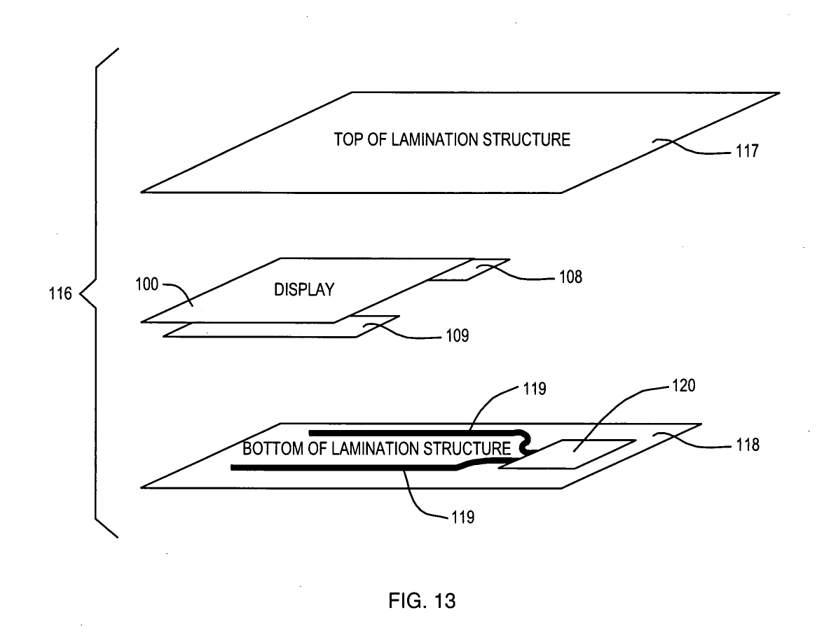

The present invention also provides for a laminated structure as illustrated in FIG. 13 using a self-adhesive display. In the case of a laminated structure 116, a top structure 117 and a bottom structure 118 sandwich the display 100. The top structure 117 may be composed of a single sheet of substrate. The bottom structure 118 has ink traces are deposed 119 other structures 120 through printing or equivalent method. The display 100 has two electrically conductive attachment layers 108, 109. By careful alignment of the attachment systems 107, 108 with the ink traces 119, the display can be integrated in the laminated structure. Ink traces 119 are printed to connect with electronic component 120.

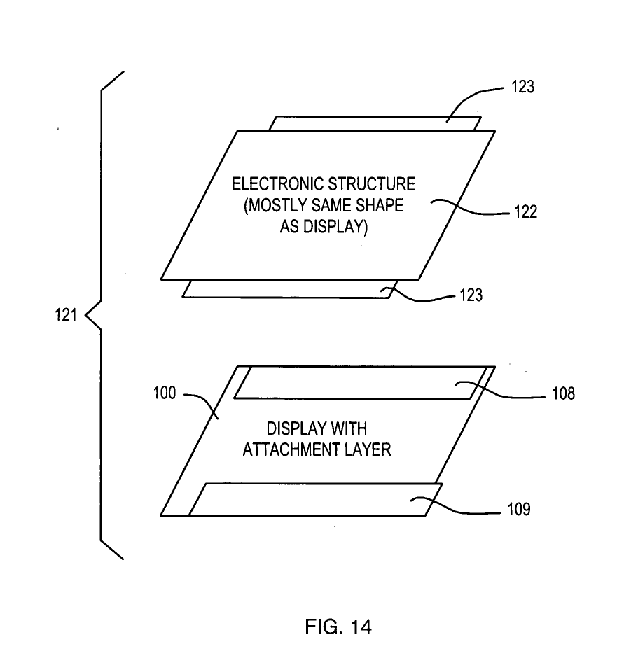

FIG. 14 shows an exploded view of an integrated module structure 121 incorporating a self-adhesive display. To create such a structure 121, the display 100, having electrically conductive attachment layers 108 and 109, is attached to a control structure 122 which has essentially the same footprint as the display 100. In this case, attachments systems 123 for the control structure 122 are aligned with a display 100 and its attachment layers 108 and 109. This approach has the advantage to support a tight integration with electronics that includes traditional thick components.

The present displays are well suited for use inside smart cards, smart labels, RFID tags, medical devices, and other small devices that require lamination processing (e.g., high temperature/high pressure lamination or low temperature/reduced pressure lamination). In some instances, the displays may be designed to withstand temperatures of 80 to 140 degree Celsius and pressures of 200 to 300 PSI for dwell times of 5 to 20 minutes.

The term smart card may be used to refer to any of a variety of electronically readable cards. These cards, which are generally small flexible cards, e.g., plastic cards about the size of a credit card, typically include a microprocessor, a memory and an interface for transmitting and receiving data from an external source. A typical smart card includes a processor coupled to an electrically erasable programmable read-only memory (EEPROM), and/or read only memory (ROM) and/or random access memory (RAM). These components are fabricated onto a single integrated substrate to further include a microprocessor for executing instructions and storing data in the memory. Such smart cards further include an input/output (I/O) signal interface for exchanging I/O signals between the smart card and an external device, such as a card reader. Communication to the reader can be through contacts or contactless (RF coupling).

Smart labels (at times also known as radiofrequency identification or RFID tags) refer to electrically powered labels that may be used to track a vast range of products. Smart labels typically include microprocessor, an antenna and an encapsulating material and/or support. The label may be powered by electric fields generated by a reader and communicate with the reader through its antenna. The label may be powered through an internal battery as well.

A device can be at the same time a smart card and a smart label.

These displays are well suited to go on devices with odds shape such as toys (say the windshield of the car), puzzles (with irregular shapes) and board games.

Self adhesive displays have key advantage when used to create a display made from multiple displays. The multiple self-adhesive displays may be integrated with electronics through a variety of means. In one embodiment, the self adhesive display is attached to a control structure 120, attachment through ink traces 119 to external electronics. In another embodiment, the self adhesive display is attached to embedded electronics. In still another embodiment, the self adhesive display is attached to electronic external to the display.

The introduction of multiple displays composing a bigger display or system requires not only provision of power, power cycling, but also provision of addressing the display in what is now a single display-tile (or tile) in a larger system. An important aspect of building such a display is to create a system that allows a big image to be divided along a series of images for what is an essentially a connection of display. To accomplish this, one need to manage the topology of the display as necessary. Thinking of a large display as a map, this management is assignment of a specific color, pattern, or image to the tile at a given latitude or longitude. Another important aspect of this management is to be able to address (for the purpose of routing information) the tile at that location.

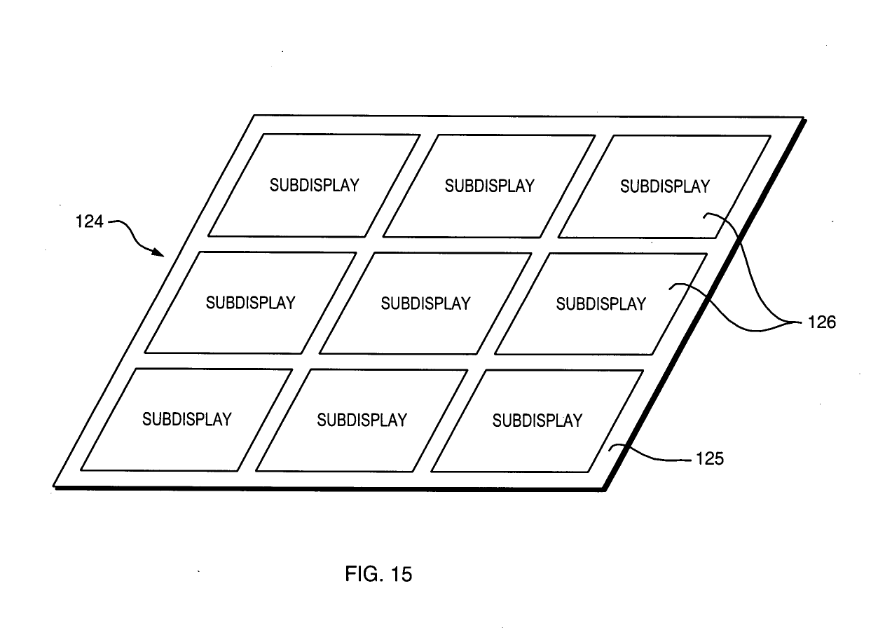

In one embodiment, multiple sub-displays may be placed on a grid supported by a physical backplane to form a larger display. This can be used to create a digital billboard or cover a large area such as building, car, vehicle, or ship. FIG. 15 shows an exemplary display structure 124 having a plurality of sub-displays 126 attached, in a regular or irregular manner, to a backplane structure 125. The display 124 is connected to a sub-display controller 127. In one embodiment, sub-display controller 127 is not a physical entity but a logical entity. The sub-display uses a memory (or equivalent database) 128 to control the sub-display address 129 associated with sub-displays 126. The memory contains information that maps the display location of each sub-display (its X and Y locations on the display 125 to a logical address 129.) The sub-display controller 127 is logically connected to the display controller 130 that uses memory (or equivalent database) 131 to manage the breakdown of images to be shown on the sub-displays based on their sub-display location. The memory 131 maps the uniquely addressable elements of the image to be displayed to those uniquely addressable elements of the display. In one embodiment, sub-display controller 127 implements a zero configuration networking algorithm to map the sub-display location. In the case of regular matrixed/pixilated system, those uniquely addressable elements are the pixels of the display and thus pixels of sub-display. When the tiled sub-displays are segments (such as in 7-segment displays or 13-segment displays), each one of those segments are uniquely addressable.

This display can now readily be build because each sub-display has a sub-display address associated with it. That display address can be stored in EEPROM, Flash, or RAM memory 129 on the sub-displays 126. This sub-display address can be an IP address or an equivalent system. The display is managed by sub-display controller 127 which hosts a database 128 of sub-display addresses. This database can be a simple flat file, link list, doubled-link list. Using a self-discovery standard such as UPnP, this controller can assign addresses to specific physical location on the display with the need for human intervention. Information on UPnP can be found on http://www.upnp.org/

This sub-display controller 127 interfaces with a display controller 130 that has responsibility to set the image/icon/pixel/color change for each sub-display location based on the image/color pattern needed across the entire display. That display can use a database 131 to facilitate that operation. In one embodiment, display controller 130 is not a physical entity but a logical entity. In one embodiment, sub-display controller 127 and display controller 130 can be a single entity. In another embodiment, sub-display controller 127 and display controller 130 can be integrated with a third entity.

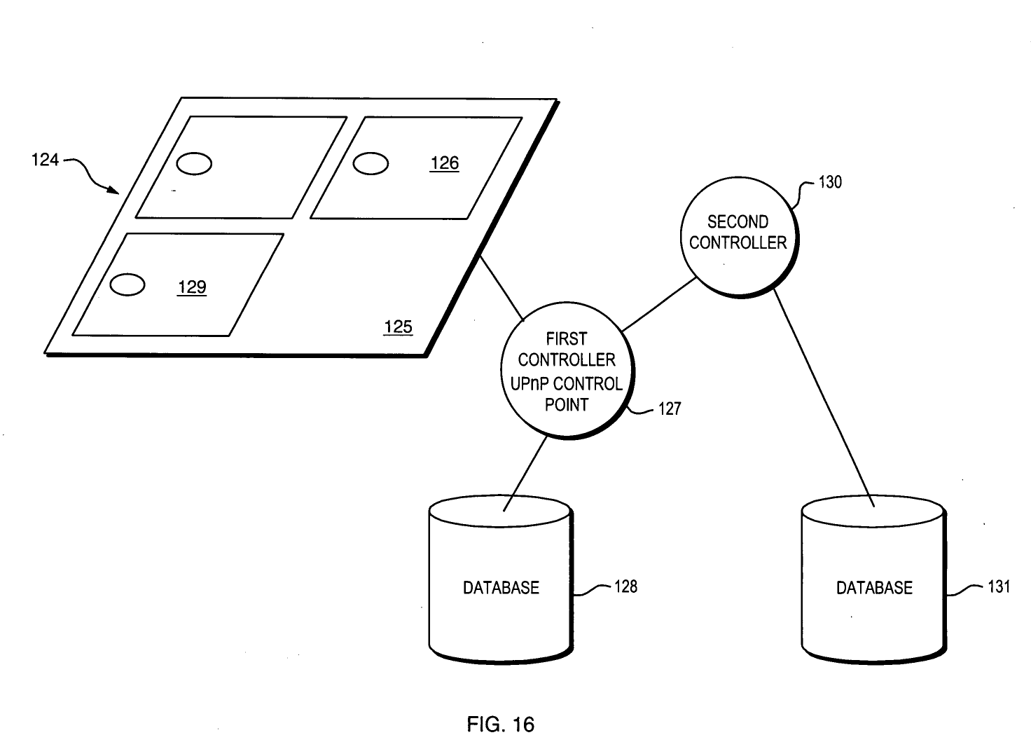

The sub-display controllers 125 and display controllers 127 can be hosted in a single device and indeed this device can be one of the sub-displays. UPnP indeed contemplates architectures where multiple devices are controlled by multiple controllers. The complexity of such algorithms makes it readily implemented inside a microcontroller. This type of architecture would have extremely good serviceability. FIG. 16 illustrates the records needed to perform the management of sub-displays. Within the memory 128, there is a series of records 132 or equivalent structures. Each record corresponds to a specific sub-display having a sub-display number 133, assigned a location in the form of latitude and longitude 134 and latitude 135. Each sub-display is assigned, dynamically by the controller 127, a logical address 136.

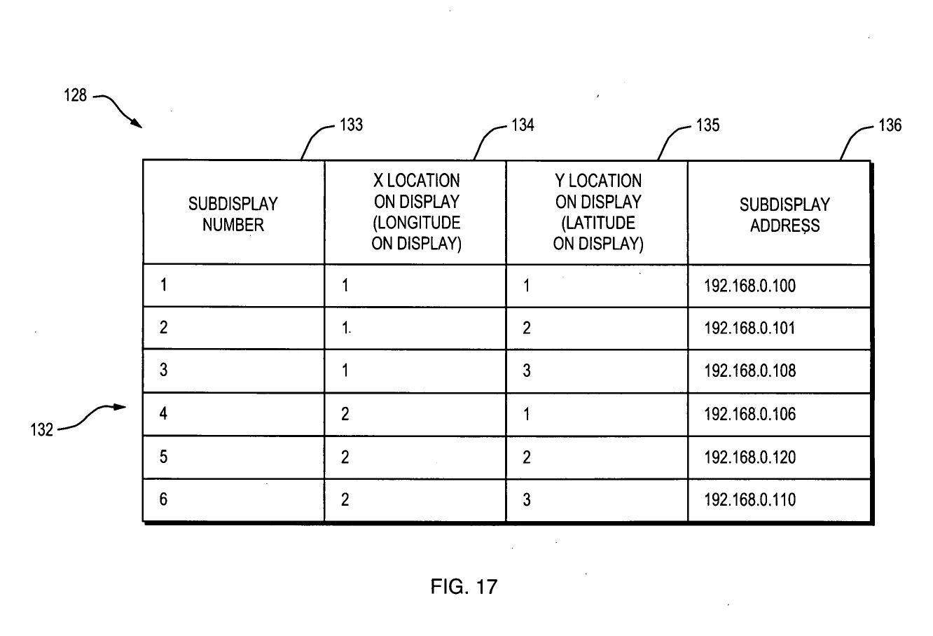

FIG. 17 illustrates the records needed to perform the management of an image on the display. Each sub-display 137 has a sub-display location represented by longitude 138 and latitude 139. Each sub-display location is associated with the corresponding sub-display number 133. In the example, sub-display 1 has four individually addressable components (locations 1-1, 1-2, 2-1, and 2-2).

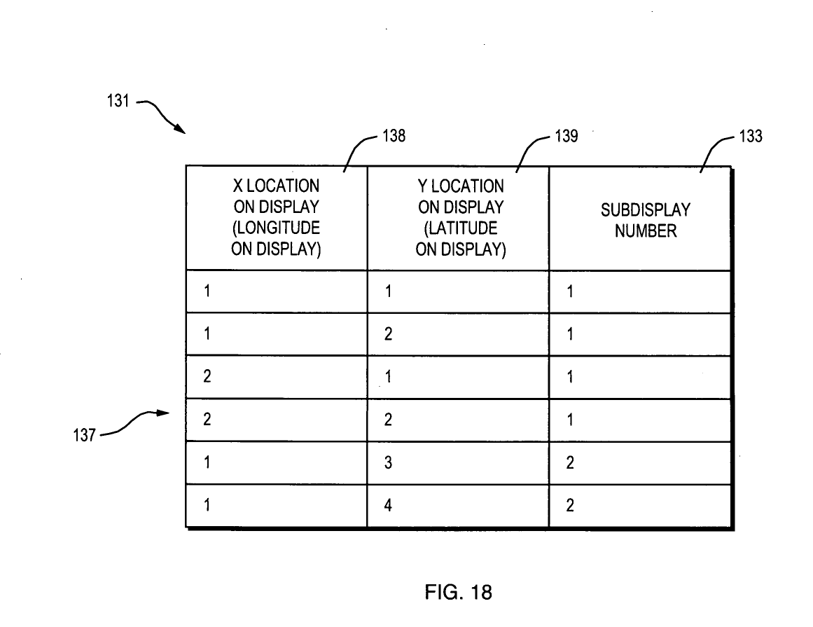

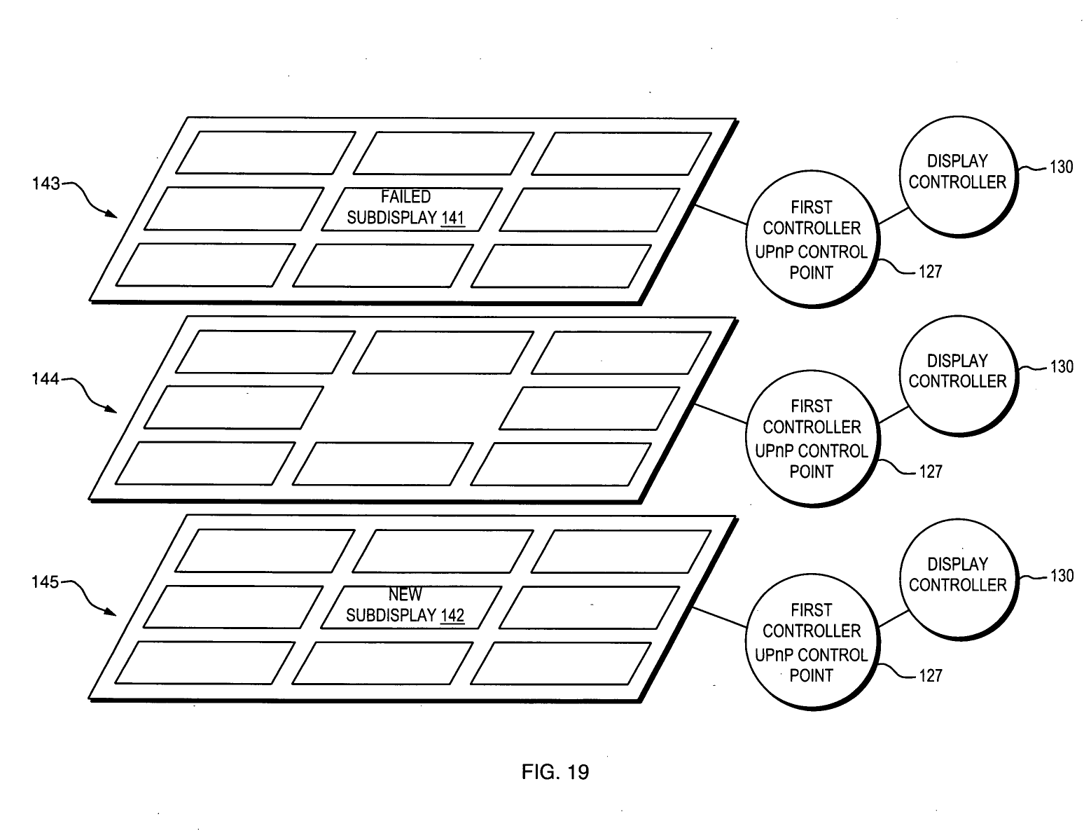

FIG. 18 shows the display 124 at three instance of time. At time 1, a sub-display 141 fails in the top view 143. This failure can be due to mechanical failure, electrical failure, or any kind of failure. At time 2, the sub-display is removed as shown in the middle view 144. At time 3, a new sub-display (142) is put in its place in the bottom view 145. The sub-display number 133 given by sub-controller 127 to the new sub-display will not change during the replacement. It is important to note that during the replacement of sub-display 141 by sub-display 142 the other sub-displays continue to operate unhindered. This is true because the change of the sub-display is transparent to the display controller 130.

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the preferred embodiments of the disclosure, it is noted that other variations and modification will be apparent to those skilled in the art, and may be made without departing from the spirit or scope of the disclosure.

What is claimed:

1. A display having a front plane, a back plane and a border edge, said display comprising:
(a) a color changing cell located behind the front plane of the device,
said color changing cell comprising:
a display active color layer having at least one active color area, said display active color layer associated with a first electrically conducting layer, said first electrically conducting layer overlapping the at least one active color area;
a counter layer associated with a second electrically conducting layer;
(b) a first electrically conducting attachment layer extending from the at least one active color area and overlapping the first electrically conducting layer; and
(c) a second electrically conducting attachment layer extending from the counter layer and overlapping the second electrically conducting layer.

2. The display of claim 1, further comprising electrically conductive tape disposed onto the at least one of the first electrically conductive attachment layer and onto the second electrically conductive attachment layer

3. The display of claim 2, wherein the electrically conductive tape is an anisotropic electrically conductive tape or an isotropic electrically conductive tape.

4. The display of claim 1, further comprising at least two first electrically conductive attachment layers extending from under at least two active color areas and overlapping the first electrically conducting layer, wherein an electrically conductive adhesive tape is disposed onto each of the at least two first electrically conductive attachment layers.

5. The display of claim 4, wherein the two first electrically conductive attachment layers extend from under the at least two active color areas to thereby create a gap of at least 25 micrometers between the two first electrically conductive attachment layers.

6. The display of claim 4 wherein the two first electrically conductive attachment layers extend from under the at least two display actives and extend to the border edge of the display device to thereby create a gap of least 25 micrometer between the two electrically conductive attachment layers.

7. The display of claim 1 wherein the color changing cell is selected from the group consisting of: an electrochromic display, a photochromic display, a Cholesteric Liquid Crystal display, an electrophoretic display, an electroluminescent display, and an electrowetting display.

8. The display of claim 1, wherein said at least one first electrically conductive attachment layer comprises an electrically conductive tape.

9. The display of claim 1, wherein said at least one second electrically conducting attachment layer comprises an electrically conductive tape.

10. An electronic device comprising the display of claim 1 operatively coupled with an electronic circuit, wherein the electronic circuit is embedded under the back plane of the display.

11. An electronic device comprising the display of claim 10, wherein the electronic circuit includes computing capabilities.

12. An electronic device comprising the display of claim 10, wherein the electronic circuit includes memory capabilities.

13. An electronic device comprising the display of claim 10, wherein the electronic circuit includes communication capabilities.

14. An electronic device comprising the display of claim 10, wherein the electronic circuit includes a plurality of addresses.

15. An electronic device comprising the display of claim 10, wherein the electronic circuit includes a printed antenna.

16. An electronic device comprising the display of claim 1, wherein the electronic circuit is disposed under the back plane of the display.

17. A device comprising the display of claim 1, operatively coupled with an electronic circuit external to said display.

18. The device of claim 17, wherein the device is selected from the group consisting of: a smart card, a smart label, an electronically readable card, an RFID tag, an electrically powered label, a smart package, a medical device, a sensor, a temperature measurement device, or a wearable medical device.

19. The device of claim 17, wherein one or more of the devices are associated with one or more of: a vehicle, a billboard, an internal wall, a container, or an external wall.

20. The device of claim 17, where the device is selected from the group consisting of: a board game, jigsaw puzzles, novelty items, board games, and toys.

21. The device of claim 17, wherein the device is a box.

22. The display of claim 17, wherein the color changing cell encompass the front side of the device.

23. A device comprising of a plurality of displays of claim 1, said device operatively coupled with a first controller and a second controller.

24. A device comprising of a plurality of displays of claim 10, said device operatively coupled with a first controller and a second controller.

25. A device comprising of a plurality of displays of claim 17, said device operatively coupled with a first controller and a second controller.

26. A device of claim 23, wherein each display has associated display location describing a location of each display on the device, and an associated display address, wherein the first controller contains a logical map correlating each display address and each display location.

27. A device of claim 24, wherein each display has associated display location describing a location of each display on the device, and an associated display address, wherein the first controller contains a logical map correlating each display address and each display location.

28. A device of claim 25, wherein each display has associated display location describing a location of each display on the device, and an associated display address, wherein the first controller contains a logical map correlating each display address and each display location.

29. A device of claim 26, wherein a zero configuration networking algorithm is implemented on first controller.

30. A device of claim 27, wherein a zero configuration networking algorithm is implemented on first controller.

31. A device of claim 28, wherein a zero configuration networking algorithm is implemented on first controller.

32. A device of claim 29, wherein said second controller assigns to each display at least one of the following: a color, an icon, a color change; a pixel; and an image, to thereby generate a device image.

33. A device of claim 30, wherein said second controller assigns to each display at least one of the following: a color, an icon, a color change; pixel; and an image, to thereby generate a device image.

34. A device of claim 31, wherein said second controller assigns to each display at least one of the following: a color, an icon, a color change; a pixel; and an image, to thereby generate a device image.
